(19) United States
(12) Patent Application Publication
(10) Pub. No.: US 2010/0026670 A1
(43) Pub. Date: Feb. 4, 2010

(54) Display device and uses thereof

(76) Inventors: Philippe Le Roy, Betton (FR); Christophe Prat, Coueron (FR); David Vaufray, Grenoble (FR)

Correspondence Address: Robert D. Shedd, Patent Operations;THOMSON Licensing LLC, P.O. Box 5312, Princeton, NJ, 08543-5312, US

(21) Appl. No.: 12/308,910

(22) PCT Filed: Jun. 20, 2007
(86) PCT No.: PCT/FR2007/001020

§ 371 Date: Sep. 23, 2009

(30) Foreign Application Priority Data
Jun. 30, 2006 (FR) 06 05955

(51) Int. Cl. G09G 5/00

(52) U.S. Cl. 345/207

(57) ABSTRACT

The invention relates to a display device comprising at least a light emitter, with power supply means suitable for the electrical supply for each emitter and the means of detection of irradiance of ambient light radiation. The detection means are also able to capture the ambient light radiation, to convert it into electrical energy and supply power to each emitter to increase the light level of each emitter according to the irradiance of ambient light radiation. The invention relates to any display system that undergoes illumination variations but for which the readability must be ensured such as computers, traffic lights or similar devices.

The present invention relates to a display device comprising at least one light element or pixel, the power supply means suitable to supply electrical energy to the element or every element, the light from each or every element according to the electrical energy supplying each or every element, and the means of detection of the irradiance of ambient light radiation, each or every element being capable of being supplied by a specific electrical energy that varies according to the irradiance of ambient light radiation.

A display device is known comprising light emitters powered by batteries, a suitable photodiode to detect the irradiance of ambient light radiation and control means capable of controlling the batteries in order to increase the electrical energy powering the emitters while the irradiance of ambient radiation is higher that a predefined value.

A prior device is known from the document U.S. Pat. No. 6,028,327 or US 2005/0260777.

Such a display device enables adjustment of the luminance level of the screen according to the irradiance of the ambient light.

However, this display device consumes more electrical energy than a standard display device as the emitters consume more electricity when the screen luminance is increased. Consequently, it is necessary to recharge the batteries regularly. However, after a certain number of recharges, the batteries are no longer usable and must be changed.

The purpose of the invention is to propose an alternative display device that consumes less electrical energy.

For this purpose, the object of the invention is a display device of the type previously cited, characterized in that it comprises detection means capable of capturing the ambient light radiation, of converting it into electrical energy and of powering each or every element with this electrical energy to increase the luminance level of each or every element according to the irradiance of ambient light radiation.

According to particular embodiments, the display device comprises one or more of the following characteristics:
the power supply means and the detection means are connected in series, and the display device comprises the switching means suitable to short-circuit said power supply means,
the means suitable to short-circuit the power supply means comprising a diode having an anode and a cathode, said anode being connected to the power supply means.
the detection means comprising at least one photovoltaic cell,
the detection means comprising for each light element at least one suitable photovoltaic cell to supply power to a single emitter, and
each light element is a light element or pixel of an OLED type display device or a light element of an LCD screen.

The invention relates also to a traffic light comprising a display device according to any one of the characteristics mentioned above.

The invention is relates also to a computer comprising a display device according to any one of the characteristics mentioned above.

The invention will be better understood upon reading the following description, provided for information only and referring to the annexed drawings wherein:

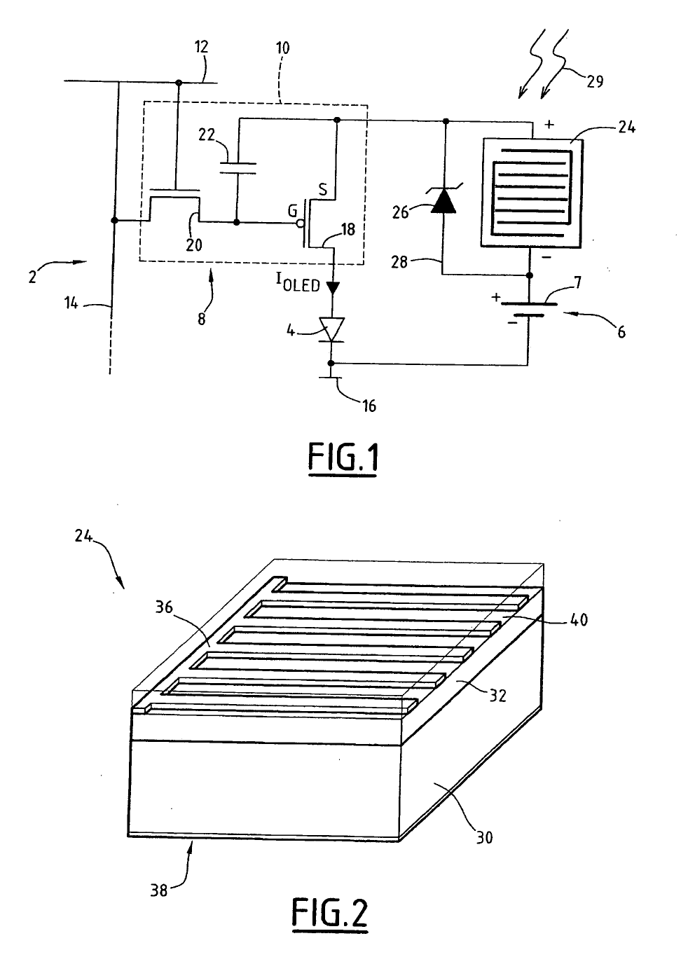

FIG. 1 illustrates a schematic view of a display device according to a first embodiment of the invention,

FIG. 2 illustrates a schematic view of a photovoltaic cell used in the display device according to the first embodiment of the invention,

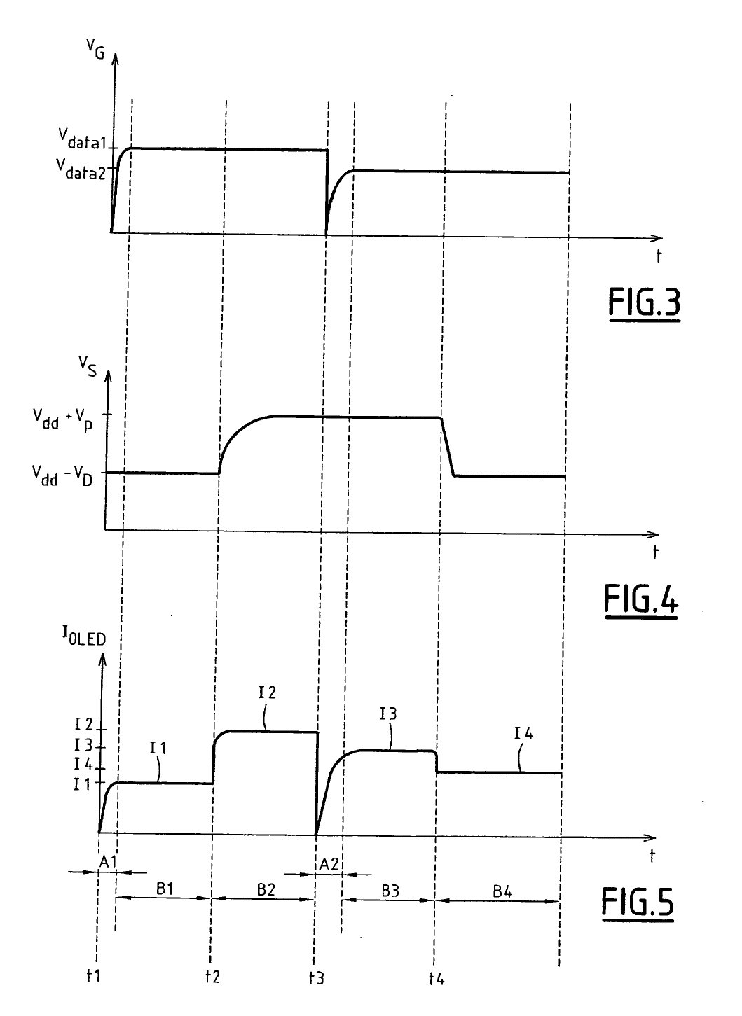

FIGS. 3 to 5 are graphs representing the progression over time of the voltage at the gate and at the source of a modulation as well as the intensity crossing an emitter of the display device illustrated on FIG. 1, and

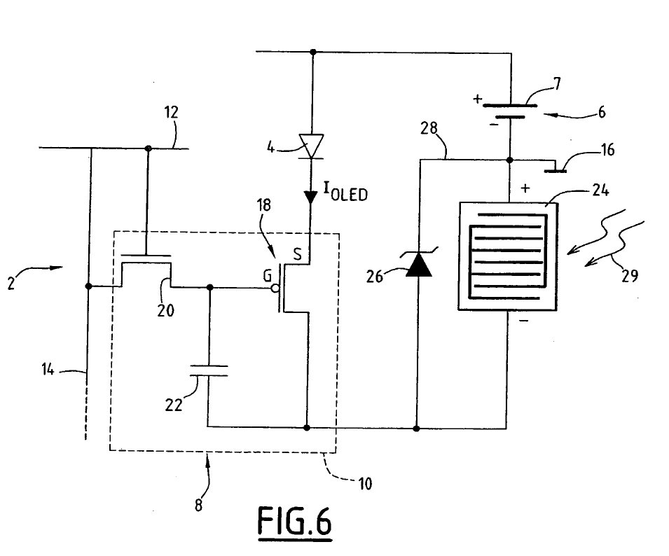

FIG. 6 is a diagrammatic view of a display device according to a second embodiment of the invention.

FIG. 1 shows a display device 2 according to a first embodiment of the invention.

Such a display device is referred to as an active matrix. It comprises a plurality of light emitters 4 forming a network of lines and columns, emitter power supply means 6 and the emission control means 8 of the emitters. For the purposes of simplification, a single emitter 4, a single power supply means 6 and a part of the control means 8 are shown in FIG. 1.

The emitters 4 of the display device are organic light-emitting diodes generally known under the acronym OLED. They comprise an anode and a cathode. They are each associated with a pixel when the display device is monochrome or with a sub-pixel when the display device is polychrome. They are suitable to emit a light intensity directly proportional to the current that crosses them.

The power supply means 6 of the emitters comprises a DC generator 7 such as for example a battery, capable of supplying an electrical voltage V_{dd}.

The control means 8 of the display device comprise an addressing circuit 10 for each emitter, a network of electrodes comprising line selection electrodes 12 and column selection electrodes 14.

The addressing circuit 10 is connected to each emitter 4 of the display device. In this circuit, the anode of emitter 4 forms the interface with the active matrix and the cathode of emitter 4 is connected to an earth electrode 16 or to a negative voltage.

The addressing circuit 10 comprises a current modulator 18, a switch 20 and a storage capacitor 22.

The current modulator 18 is a thin film transistor based on a technology using polycrystalline silicon (poly-Si) or amorphous silicon (a-Si) or single-crystal or microcrystalline silicon or on an organic technology deposited in thin layers on a glass substrate. Such components comprise three electrodes: a drain electrode and a source electrode S between which circulates a modulated drain current, and a gate electrode G to which is applied a given voltage V_{data1}.

The TFTs (Thin Film Transistor) are of N or P type. The modulator 18 shown in FIG. 1 is of P type. Its source S is connected indirectly to the power supply means 6 and its drain is connected directly to the anode of the emitter 4, so that in operation, the modulated drain current circulates between its source and its drain.

The switch 20 is also a transistor based on the technology using polycrystalline silicon (poly-Si) or amorphous silicon (a-Si) or single-crystal or microcrystalline silicon or an organic technology deposited thin layers. One of these electrodes (drain or source) is connected to the addressing electrode 14 and the other electrode (drain or source) is connected to the gate of the modulator 18. Its gate is connected to the selection electrode 12.

The storage capacitor 22 is connected between the gate and the modulator source 18 to maintain a constant voltage on the gate of the modulator 18 and to thus maintain the emitter brightness 4 for the duration of the picture frame.

The network of selection electrodes 12 and addressing electrodes 14 enables selection and addressing of a specific emitter 4 from among the set of emitters of the display device.

Every selection electrode 12 is connected to the gate of switches 20 of a line and is capable of transmission of a selection voltage V_{select} to the set of emitters 4 of this line to open the switches 20. The selection voltage V_{select} is a logic data of emitters selection.

Each addressing electrode 14 is connected to the source or drain of the switches 20 of a column and is capable of addressing a data voltage V_{data1} to one of the electrodes (drain or source) of the switches 20 of this column.

The intensity of the current in the emitter 4 is proportional to the amplitude of the data voltage V_{data1} that is applied to the addressing electrode 14.

The display device 2 also comprises a photovoltaic cell 24 connected in series the power supply means 6 and a Schottky diode 26 connected to a branch 28, in parallel to the photovoltaic cell 24.

The photovoltaic cell 24 is capable of detecting and capturing the ambient light radiation 29, and of converting it into electrical energy to supply power to the emitter 4.

Hence, the photovoltaic cell 24 is suitable for the detection of the irradiance of ambient light radiation and power supply of the emitter 4 using captured light energy 29.

The ambient radiation 29 is either solar radiation or radiation from another light source, such as a lamp for example.

When the display device according to the invention equips a computer or telephone, the light source is preferably independent of it.

According to the embodiment shown in FIG. 2, the photovoltaic cell 24 comprises a layer 30 of type P semiconductor material and a layer 32 of type N semiconductor material deposited on the layer 30.

The photovoltaic cell 24 also comprises electrical contacts 36 and 38 arranged on either side of layers 30 and 32 and an anti-reflection film 40 on contact 36.

The electrical contact 36 corresponds to the negative terminal of the photovoltaic cell 24 and is connected to the voltage generator 7. The electrical contact 38 corresponds to the positive terminal of the photovoltaic cell 24 and is connected to the modulator source 18.

The contacts 36 and 38 are capable of drawing the electrical current induced by the transport of electrical charges between the layer of type P semi-conductor material 30 and the layer of type N semi-conductor material 32. In fact, during the reception of light radiation photons 29, the electrical charges and the N type and P type semi-conductor holes move to create an electrical current between the contacts 36 and 38.

When the semi-conductor material of layers 30 and 32 is constituted of silicon, the voltage generated by the photovoltaic cell 24 is comprised for example between 0.45 and 0.5 V.

The voltage between the contacts 36 and 38 of the photovoltaic cell 24 is relatively independent of the light radiation irradiance intercepted by the reception surface of the cell. The current induced between the contacts 36 and 38 is however capable of significantly increasing with the increase of the irradiance of the captured radiation.

A photovoltaic cell with a surface of 100 cm² is for example suitable for generating a current of about 2.2 A, 1.4 A and 0.4 A and a voltage of about 0.5 V when subjected to a light radiation irradiance respectively of 1000 W m⁻² s⁻¹, of 600 W m⁻² s⁻¹ and of 200 W m⁻² s⁻¹.

The branch 28 and the diode 26 constitute the means authorizing the passage of current only from the cathode of the generator 7 to the source of the modulator 18.

According to the embodiment described, the Schottky diode 26 has a triggering threshold V_{D} equal to 0.2 V for example.

The anode of the Schottky diode 26 is connected to the positive terminal of the power supply means. The cathode of the Schottky diode is connected to the source of the modulator 18 in such a way that when the photovoltaic cell is not lighted, the current from the power supply means 6 is able to cross the Schottky diode 26 to supply power to the emitter 4 via the modulator 18.

As a variant, several photovoltaic cells 24 are connected in series and connected to the source of the modulator 18 and to the positive terminal of the power supply means 6 to increase the power supply voltage of the emitter 4.

As a variant, several photovoltaic cells 24 are connected in parallel and connected to the source of the modulator 18 and to the positive terminal of the power supply means 6 to increase the power supply current of the emitter 4.

In operation, at the time t1, the display device 2 is situated in a dimly lit environment, such as inside an office for example or in an underground transport system.

In this patent application, it is considered that a dimly lit environment corresponds to an environment in which the irradiance is less than 100 W m² and that a brightly lit environment corresponds to an environment in which the irradiance is greater than 100 W m⁻².

A potential V_{dd} corresponding the power supply voltage of the power supply means 6 is applied to the source of the modulator 18.

During an initialisation stage A1, a voltage V_{select} is applied to the line selection electrode 12. In parallel, a data voltage V_{data1} is applied to the column addressing electrode 14. The switch 20 connected to both the line selection electrode 12 selected and the column addressing electrode 14 addressed opens.

The potential at the modulator gate 18 and at the capacitor terminal becomes equal to V_{data1}.

When the difference in potential between the gate and the source of the modulator 18 is greater than the voltage of the triggering threshold of the modulator 18, a drain current I_{OLED} is established between the drain and the source of the modulator 18. It crosses the emitter 4 that lights up during an illumination stage B1. The difference in potential between the gate and the source of the modulator 18 is equal to V_{dd}−V_{D}−V_{data1}. The drain current crossing the emitter I_{OLED} is equal to I1.

When the display device is situated in a dimly lit environment, the branch 28 and the diode 26 enable the photovoltaic cell 24 to be short-circuited, the latter behaving like an open circuit.

At the time t2, the display device 2 is situated in a more brightly lit environment such as for example outside or in a brightly lit room.

The photovoltaic cell 24 captures the light radiation 29 and supplies a voltage Vₚ that stabilizes at for example 0.5 V after a transitory phase.

When the display device is situated in a brightly lit environment, the diode 26 behaves like a charge so that the voltage supplied by the generator 7 and the voltage supplied by the photovoltaic cell 24 are added together.

As the photovoltaic cell 24 is connected in series to the power supply means 6, a potential equal to V_{dd}+Vₚ is applied to the source of the modulator 18. The difference in potential between the gate and the source of the modulator 18 is then equal to V_{dd}+Vₚ−V_{data1}.

The drain current I_{OLED} crossing the emitter 4 is equal to 12 during an illumination stage B2. As the intensity of the drain current I_{OLED} varies proportionally with the increase of the difference in potential between the gate and the source of the modulator 18, the drain current 12 crossing the emitter 4 has an intensity that is greater than the intensity of the drain current I1 generated during stage B1 for the same data voltage V_{data1}.

During an initialization stage A2 of a new picture frame, at the time t3, a data voltage V_{data2} less than the date voltage V_{data1} is applied to the addressing electrode 14. In parallel, a selection voltage V_{select} is applied to the gate of the modulator 18. The switch 20 is open so that the voltage at the gate of the modulator 18 and the terminal of the capacitor 22 is equal to V_{data2}.

As the photoelectric cell 24 is still situated in a brightly lit environment, the difference in potential between the gate and the source of the modulator 18 is V_{dd}+Vₚ−V_{data2}.

The drain current I_{OLED} crossing the emitter 4 is equal to 13 during an illumination stage B3. The drain current 13 crossing the emitter 4 then has an intensity that is less than the current 12 having crossed the emitter 4 during stage B2.

At the time t4, the display device 2 is situated in a less brightly lit environment. The photovoltaic cell 24 no longer generates the power supply voltage Vₚ. The difference in potential between the gate and the source of the modulator 18 is equal to V_{dd}−V_{D}−V_{data2}.

The drain current 14 crossing the emitter 4 has an intensity that is less than the intensity of the drain current 13 generated during stage B3 for the same data voltage V_{data2}.

Hence, the luminance level of the emitter 4 varies according to the irradiance of the radiation captured by the photovoltaic cell 24.

FIG. 6 shows an active matrix display device according to a second embodiment of the invention.

In this second embodiment, the modulator 18 used in the addressing circuit 10 is of N type.

The display device according to this second embodiment comprises the same components as the display device according to the first embodiment. These have been referenced by the same references and will not be described again.

In this second embodiment, the source of the modulator 18 is connected to the cathode of the emitter 4. The anode of the emitter 4 is connected to the cathode of the generator 7. The anode of generator 7 is connected by one part to the photovoltaic cell 24 and by another part to the cathode of the Schottky diode 26. The photovoltaic cell 24 is connected in series to the generator 7. The anode of the Schottky diode 26 and one of the contacts of the photovoltaic cell 24 are connected by one part to the drain of the modulator 18 and by another part to the capacitor 22.

When the photovoltaic cell 24 is situated in a brightly lit environment, the potential at the source of the modulator 18 varies from a value noticeably equal to the value of the voltage generated by the photovoltaic cell 24. The difference in potentials between the gate and the source of the modulator 18 increases in such a way to increase the current of the drain crossing the emitter 4 and the modulator 18.

According to a third embodiment of the invention shown in FIG. 7, the power supply means 6 and the photovoltaic cell 24 are suitable to power an emitter of a backlight device of a plasma screen or an LCD screen.

The display device according to the invention can be used in a traffic light, in a computer, a personal digital assistant or a telephone.

The photovoltaic cell 24 is placed behind the OLED or LED screen.

As a variant, the current modulator 18 is a thin film transistor based on an organic or metallic semiconductor substrate.

As a variant, the photovoltaic cell 24 is organic and is associated with an organic active matrix.

As a variant, the Schottky diode is replaced by a semiconductor that authorizes the passage of current only in one direction, such as for example a transistor mounted as a diode or a set of two transistors arranged head to tail.

Advantageously, the photovoltaic cell 24 is suitable to detect the presence of light and to supply power to the emitter 4 proportionally to the irradiance illuminating the photovoltaic cell 24. Hence the luminance of the display device 2 is automatically adjusted to ambient lighting. When the display device is situated by a user in a very brightly lit environment, the display device is able to automatically increase its brightness and contrast so that the user can read the information displayed on it.

Advantageously, the screen luminance is adapted to the ambient luminosity without reduction of the electrical autonomy of the display device.

Advantageously, this display device is very simple to produce.

1. A display device comprising:
at least one luminous element or pixel,
power supply means suitable to supply in electrical energy each or every element, the luminance from each or every element being according to the electrical energy supplying each or every element.
the means to detect the irradiance of ambient light radiation, each or every element being capable of being supplied by electrical energy suitable to vary according to the irradiance of ambient light radiation,
wherein the detection means are also able to capture the ambient light radiation, to convert it into electrical energy and supply power to each or every element with this electrical energy to increase the light level of each element according to the irradiance of ambient light radiation and in that said power supply means and said detection means are connected in series, the device comprising means suitable to short-circuit said power supply means.

2. The display device according to claim l, wherein said means suitable to short-circuit the power supply means comprise a diode with an anode and a cathode, said anode being connected to the power supply means.

3. The display device according to claim 1, wherein the detection means comprise at least one photovoltaic cell.

4. The display device according to claim 1, wherein the detection means comprise for each luminous element, at least one photovoltaic cell suitable to supply power to a single emitter.

5. The display device according to claim 1, wherein each luminous element is a luminous element or pixel of an OLED type display device or a luminous element of a LCD screen.

6. A traffic light, comprising a display device according to claim 1.

7. A computer, comprising a display device according to claim 1.
